(19) United States
(12) Patent Application Publication
(10) Pub. No.: US 2010/0318826 A1
(43) Pub. Date: Dec. 16, 2010

(54) Changing Power States Of Data-Handling Devices To Meet Redundancy Criterion

(76) Inventors: Peter Hansen, Cypress, TX (US); Darren Cepulis, Houston, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/867,185

(22) PCT Filed: Feb. 15, 2008
(86) PCT No.: PCT/US08/54164

§ 371 Date: Aug. 11, 2010

(51) Int. Cl. G06F 1/28; G06F 1/32

(52) U.S. Cl. 713/323; 713/340

(57) ABSTRACT

A computer system provides for changing the power states of data-handling devices in response to a detection of a change in the redundancy associated with energy-transfer devices.

### BACKGROUND OF THE INVENTION

Mission-critical and high-availability computer applications, e.g., government and commerce sites on the World Wide Web, often require high levels of redundancy to minimize down time due to equipment failures. This applies not only to data-handling elements such as processors, media (including disks and solid-state memory), and communications devices (including input/output devices and network interface devices), but to energy transfer devices, such as power supplies (which bring electrical energy into the computer) and cooling devices such as fans (which remove heat energy from the computer). For example, a system can provide more power supplies than needed so that if one fails, the system can continue operating without interruption.

Minimal redundancy addresses only a single point of failure. In the above example, if a second power supply fails before the first is repaired or replaced, the entire computer may fail. In many cases, this interruption may be rare enough to be tolerable, in other cases, it may not be acceptable. In the latter case, additional power supplies can be used to provide more redundancy, but at some point the costs (economic and bulk) outweigh the benefits. What is needed is a way to enhance up time for a given level of initial redundancy.

Herein, related art is described to facilitate understanding of the invention. Related art labeled “prior art” is admitted prior art; related art not labeled “prior art” is not admitted prior art.

### BRIEF DESCRIPTION OF THE DRAWING

The FIGURE depicts implementations/embodiments of the invention and not the invention itself.

FIG. 1 is a combination diagram including a block diagram of a computer system incorporating redundancy and a flow chart of a method providing for said control in accordance with an embodiment of the invention.

### DETAILED DESCRIPTION

The present invention provides for changing the power states of data-handling devices (DHDs) to meet a redundancy criterion for energy-transfer devices (ETDs). For example, when redundancy is lost because of the failure of one of three or more power supplies, the power states of processors and other DHDs can be lowered so that power needs can be met even in the event a second power supply fails. Likewise, if the ambient temperature increases to the point where the current set of fans is no longer redundant, DHD power states can be reduced to restore redundancy. On the other hand, if the ambient temperature goes down, the invention can provide for increasing power states in exchange for reduced excess redundancy.

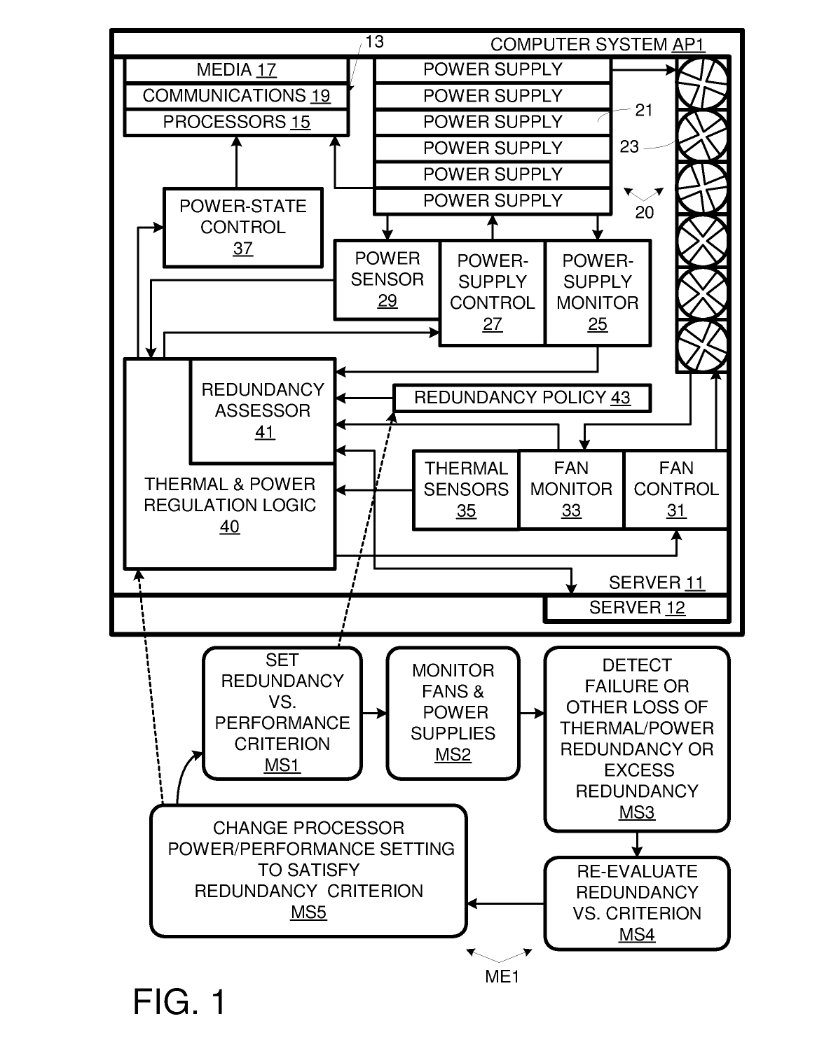

A computer system AP1 includes essentially similar servers 11 and 12, as shown in FIG. 1. Server 11 includes data-handling components 13, including: 1) processors 15 for manipulating data in accordance with programs of instructions; 2) computer-readable media 17, including main memory, other solid-state media, and disk-based media) for storing said programs and data; and 3) communications devices 19 including input/output devices and other communications devices such as network interface cards. In addition, server AP1 includes energy transfer devices 20, including power supplies 21 and cooling devices 23 such as fans. Associated with power supplies 21 are a power supply monitor 25, a power supply controller 27, and a power sensor 29. Associated with fans 23 are a fan controller 31, a fan monitor 33, and thermal sensors 35. A power power-state controller 37 controls the power states of data-handling components, e.g., according to the ACPI standard.

Power-state controller 37 is responsive to thermal and power regulation logic 40, which controls the operation of power supplies 21 and fans 23 respectively via power-supply controller 27 and fan controller 31. Logic 40 includes a redundancy assessor 41, which evaluates the level of redundancy for power supplies 21 and fans 23 according to a redundancy policy 43, one of several management-defined policies implemented for server AP1.

Server AP1 includes six power supplies 23, although this number varies across embodiments. Power-supply controller 27 can switch each functional power-supply between active and reserve status. Normally, four power supplies can supply enough power for server 11; in this case, five can be active and one left inactive in reserve. If one fails, the other four suffice to continue operation while the reserve power-supply is activated. System operation is not interrupted but redundancy is lost. If another power supply fails, system operation will be interrupted. The invention avoids this interruption by reducing power states so that three power supplies can provide continued operation of the system.

Power-supply monitor 25 monitors the “health” of power supplies 21, and detects when a power supply fails. Power sensor 29 tracks the power output by power supplies 21. The power sensor data can be used to detect a high-demand situation in which redundancy can be lost due to increased loads on power supplies 21.

Server 11 includes six fans 23. Fan controller 31 can switch fans on and off individually and control fan speed for those fans that are on. Fan monitor 33 monitors the health of fans 23 to detect failure or impaired operation. Thermal sensors 35 or “thermometers” track internal and ambient temperatures for use in regulating the speed of fans 23.

Thermal and power regulation logic 40 receives inputs from thermal sensors 35 for use in regulating fan speeds. It also receives data from power sensor 29 indicating the actual power consumption by server 11. Assessment of the redundancy state of server 11 is made by redundancy assessor 41 of logic 40.

Redundancy assessor 41 is responsible for implementing redundancy policy 43. Redundancy policy 43 is typically set by a system administrator. This policy 43 specifies desired levels of redundancy and the actions that can be taken to achieve those levels. Redundancy assessor 41 is coupled to power supply monitor 25 and to fan monitor 33 so that it is informed of the numbers of active, inactive, and failed power supplies and fans. In addition, redundancy assessor 41 is coupled to server 12 for implementing policies that take the state of an external server into account. (For example, a lower local redundancy may be required for server 11 if server 12 has high redundancy than if server 12 has low redundancy.)

Some simple redundancy policies ignore external servers and treat power and cooling independently. One power policy is to lower power states of data-handling components to restore redundancy in the event of a power-supply failure. A comparable cooling policy would be to lower power states in the event of a fan failure to restore redundancy. More complex policies can take such factors as performance demands and the redundancy available in other servers such as server 12, into account. For example, a policy might accept a limited duration of sub-standard redundancy when high performance was required.

Other policies accept lower cooling system redundancy when power-supply redundancy is high, and vice versa. The justification would be that a certain overall likelihood of failure might be tolerable. For example, a policy might tolerate a single point of failure for power-supplies 21 when the redundancy of fans 23 is high because the overall likelihood of failure is sufficiently low, while if both power supplies and fans lacked redundancy, the changes of a failure would be too high and redundancy would have to be restored to at least one of these subsystems. Another policy gives up redundancy in one subsystem when redundancy in another subsystem is low on the theory, that the low redundancy of the first subsystem is not the most likely cause of failure. As these examples demonstrate, the invention provides for a wide range of redundancy policies.

A method ME1 of the invention is flow charted in the lower portion of FIG. 1. The redundancy-versus-performance criterion is set or selected at method segment. MS1. This criterion is specified by redundancy policy 43. Fans 23 and power supplies 21 are monitored on an ongoing basis at method segment MS2, which can overlap all other method segments in method ME1. At method segment MS3, some change affecting redundancy is detected. This change can be a failure of a power supply or a fan. Logic 40 can respond by forcing power-state controller 37 to implement to a lower power state for processor 15, and/or for media 17 and communications devices 19.

Method segment MS3 can involve the detection of a change in temperature. For example, an increase in ambient temperature affects the cooling power of fans 21. Redundancy can be lost when a fan counted as redundant becomes required to achieve sufficient cooling for operation to continue because the air used for cooling has increased in temperature. Logic 40 can call for a decrease in power state to restore redundancy in this case. Likewise, a decrease in ambient temperature can increase cooling efficiency of the fans, increasing redundancy. A redundancy policy can specify a level of excess redundancy that, when detected, can result in an increase in a power state to achieve higher performance. In this sense, the redundancy criterion can specify a maximum as well as a minimum redundancy level; the maximum indicating when redundancy can be reduced by increasing power state levels for data-handling devices.

Once a change affecting redundancy is detected at method segment MS3, the resulting redundancy is evaluated against the redundancy criterion established at method segment MS1. If the changed condition does not meet the criterion, power states can be changed at method segment MS5 to meet the criterion.

In one scenario, a power supply fails. System operation is not interrupted, but redundancy is lost. The power states of the data-handling devices cannot be lowered fast enough to prevent operation from being interrupted. Thus, power states are lowered, e.g., from P0 to P3, in advance of any failure to restore redundancy. If a second failure occurs, the system can continue uninterrupted. When the failed power supply is replaced (physically, or by activation of a reserve power supply) the power states of the data-handling devices can be raised again, e.g., from P3 to P0.

The Advanced Configuration and Power Interface (ACPI) specification is an open industry standard first released in December 1996 developed by HP, Intel, Microsoft, Phoenix, and Toshiba that defines common interfaces for hardware recognition, motherboard and device configuration and power management. ACPI brought power management features previously only available in portable computers to desktop computers and servers. For example, systems may be put into extremely low consumption states; in such a state, a device such as a real-time clock, a keyboard, or a modem can trigger a “general-purpose event” (GPEs, similar to interrupts), to quickly wake the system.

The present invention can apply to systems that have sufficient resources to handle at least two failures relating to energy-transfer devices. Typically, three or more power supplies and three or more fans would be available, but some embodiments require fewer such components. Multi-computer-systems can have policies that interact across computers so that the redundancy of one computer can be taken into account in setting the redundancy of another computer. Different numbers of fans and different types of cooling devices (e.g., liquid heat exchangers) can be employed. These and other modification to and variations upon the disclosed embodiments are provided for by the present invention, the scope of which is defined by the following claims.

What is claimed is:

1. A method comprising:
selecting a redundancy criterion for energy-transfer devices installed in a computer system;
monitoring said energy-transfer devices to track redundancy levels associated with said energy-transfer devices;
detecting when said energy-transfer devices fail to meet said redundancy criterion; and
changing one or more power states of one or more data-handling devices of said computer system so that said criterion is met.

2. A method as recited in claim 1 wherein said energy-transfer devices include power supplies and fans.

3. A method as recited in claim 1 wherein said detecting is in response to a failure of an energy-transfer device.

4. A method as recited in claim 1 wherein said detecting involves detecting a change of temperature.

5. A method as recited in claim 2 wherein said criterion treats said power supplies and said fans independently.

6. A method as recited in claim 1, wherein said changing the power state involves lowering a power state of a processor.

7. A method as recited in claim 1 wherein said changing a power state involves increasing a power state of a processor.

8. A method as recited in claim 1 wherein said criterion is a function in part of a redundancy state of another computer system.

9. A method as recited in claim 1 wherein said criterion is a function in part of a demand on said processors.

10. A method as recited in claim 1 wherein said criterion is a function in part of actual power provided by power supplies.

11. A computer system comprising:
one or more data-handling devices having selectable power states;
a power-state controller for selecting power states for said data-handling devices;
energy-transfer devices including power supplies and heat-removal devices;
one or more monitors for detecting when said energy-transfer devices fail to meet a redundancy criterion; and
redundancy control logic coupled to said monitor means and to said processor controller for changing the power state of said processors so as to meet said redundancy criterion.

12. A system as recited in claim 11 wherein said redundancy control logic reduces said power states to restore redundancy.

13. A system as recited in claim 11 wherein said redundancy control logic increases said power states to remove excess redundancy.

14. A system as recited in claim 11 wherein said one or more monitors detect a failure of an energy-transfer device.

15. A system as recited in claim 11 wherein said monitors include a sensor for detecting when said energy-transfer devices lose redundancy due to an increase in temperature.

16. A system as recited in claim 11 wherein said data-handling devices include data processors for manipulating data in accordance with programs of instructions.

17. A system as recited in claim 11 wherein said criterion includes independent sub-criterion for power supplies and for fans.

18. A system as recited in claim 11 wherein said criterion includes sub-criteria for power supplies and fans that interact.

19. A system as recited in claim 11 wherein said criterion is a function in part of the state of another computer system.

20. A system as recited in claim 11 wherein said power states conform to an ACPI standard.
